(19) United States
(12) Patent Application Publication
(10) Pub. No.: US 2026/0295518 A1
(43) Pub. Date: Oct. 1, 2026

(54) IMPROVED ELECTRODES FOR ELECTROCHEMICALLY DRIVEN CARBON DIOXIDE SEPARATOR

(71) Applicant: Repair DAC Ltd., Zichron Yaacov (IL)

(72) Inventors: Ben Achrai, Yokneam llit (IL); Naama Gluz, Pardes-Hanna Karkur (IL); llya Kogan, Tirat HaCarmel (IL); Ludmila Naama Lenivtsev, Yokneam llit (IL)

(73) Assignee: Repair DAC Ltd., Zichron Yaacov (IL)

(21) Appl. No.: 19/475,878

(22) PCT Filed: Apr. 16, 2024
(86) PCT No.: PCT/IB2024/053695

§ 371 Date: Oct. 16, 2025

Related U.S. Application Data
(60) Provisional application No. 63/496,461, filed on Apr. 17, 2023.

(51) Int. Cl. B01D 53/32

(52) U.S. Cl. CPC B01D 53/326; B01D 2255/20753; B01D 2255/806; B01D 2257/504

(57) ABSTRACT

An electrode for use in an electrochemically driven carbon dioxide separator (EDCS) includes a porous and electrically conductive substrate having two opposing sides, in which only one of the sides is coated with an electro-catalytic coating, the other side being an uncoated side. The electro-catalytic coating includes a charge-storage compound that reacts to form hydroxide when acting as a cathode and reacts to consume hydroxide or produce protons when acting as an anode.

### FIELD OF THE INVENTION

The present invention relates to gas diffusion electrodes having improved process performance of electrochemically based separation of carbon dioxide gas from gas mixtures.

### BACKGROUND OF THE INVENTION

US Patent Application 2021/0036350 to Yushan Yan et al. describes an electrochemical pump (BCP) for separating carbon dioxide from a carbon dioxide-containing gas, such as air. The ECP includes a cell, which has a membrane and two electrodes that are capable of acting as an anode or a cathode. Each of the electrodes independently comprises a charge-storage compound that reacts to form hydroxide when acting as cathode and reacts to consume hydroxide or produce protons when acting as anode. The membrane is adjacent to and separates the two electrodes. A carbon dioxide-containing gas contacts the electrode acting as cathode and the carbon dioxide reacts with the hydroxide ions to form bicarbonate ions, carbonate ions, or bicarbonate and carbonate ions; the bicarbonate ions, carbonate ions, or bicarbonate and carbonate ions are transported to the electrode serving as anode through the membrane; and the bicarbonate ions, carbonate ions, or bicarbonate and carbonate ions react at the electrode acting as anode to form carbon dioxide and water. The ECP also has means for reversing the direction of current flow and simultaneously alternating the electrode with which the carbon dioxide-containing gas is contacted, thereby allowing each electrode to act, in turn, as anode and as cathode.

A standard, prior art electrode preparation procedure may involve electrodeposition step of nickel hydroxide onto a porous and electrically conductive substrate, resulting in the formation of solid nickel hydroxide phase coating of the porous structure walls or wires. The nickel hydroxide coating also fills the internal pores of the porous structure and coats its external nominal (geometrical) face. Types of a porous substrate layer may include mesh, foam, honeycomb, etc.

The layered electrodes are then assembled with an anion exchange separator in between them, forming a membrane electrode assembly (MEA). The MEA is then placed between two conductive layers having inlets and outlets for gas feed, which are connected by flow channels to allow homogenous gas distribution over the electrodes surface.

### SUMMARY

The present invention seeks to provide an innovative method to prepare gas diffusion electrodes having improved process performance of an electrochemically driven carbon dioxide separator (EDCS).

There is provided in accordance with a non-limiting embodiment of the invention, an electrochemically driven carbon dioxide separator (EDCS) including an anion exchange separator (such as in the form of a membrane) placed between two electrodes, each of the electrodes includes a porous and electrically conductive substrate having two opposing sides, wherein only one of the sides is coated with an electro-catalytic coating, the other side being an uncoated side, and wherein the electro-catalytic coating includes a charge-storage compound that reacts to form hydroxide when acting as a cathode and reacts to consume hydroxide or produce protons when acting as an anode.

As in the prior art, a carbon dioxide-containing gas contacts the electrode acting as cathode and the carbon dioxide reacts with the hydroxide ions to form bicarbonate ions, carbonate ions, or bicarbonate and carbonate ions; the bicarbonate ions, carbonate ions, or bicarbonate and carbonate ions are transported to the electrode serving as anode through the membrane; and the bicarbonate ions, carbonate ions, or bicarbonate and carbonate ions react at the electrode acting as anode to form carbon dioxide and water. The EDCS has means for reversing the direction of current flow and simultaneously alternating the electrode with which the carbon dioxide-containing gas is contacted, thereby allowing each electrode to act, in turn, as anode and as cathode. The EDCS has inlets and outlets for gas feed, which are connected by flow channels to allow homogenous gas distribution over the electrodes surface. The EDCS is connected to a power source which applies an electrical current/potential to the electrodes.

### BRIEF DESCRIPTION OF DRAWINGS

The present invention will be understood and appreciated more fully from the following detailed description, taken in conjunction with the drawings in which:

FIG. 1A is a light microscopy image of a gas diffusion electrode with a single-sided coating, such as a nickel hydroxide coating, in accordance with a non-limiting embodiment of the present invention, wherein there is no nickel hydroxide coating on the blocked side of the electrode.

FIG. 1B is a light microscopy image of a prior art gas diffusion electrode with a double sided coating which has nickel hydroxide coating on its blocked side.

FIG. 2 is a graphical illustration of CO₂ levels in the cathode outlet of the EDCS-based direct-air-capture (DAC) cell for the prior art double-sided (DS) coating on the electrode and the inventive one-sided (OS) coating on the electrode. Both tests included atmospheric air in the inlet gas, the same current density and the same (generic) cell hardware.

FIG. 3 is a graphical illustration of electrical potential of the EDCS-based DAC cell for the prior art double-sided (DS) coating on the electrode and the inventive one-sided (OS) coating on the electrode. Both tests included the same current density and the same (generic) cell hardware.

FIG. 4 is a graphical illustration of energy consumption of the EDCS-based DAC cell for the prior art double-sided (DS) coating on the electrode and the inventive one-sided (OS) coating on the electrode.

### DETAILED DESCRIPTION

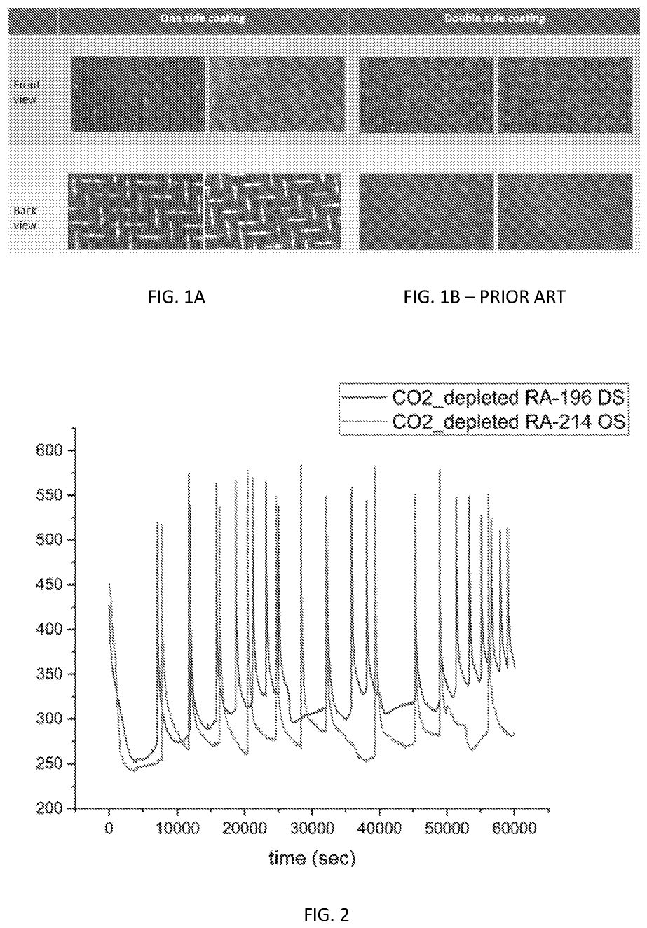

Reference is now made to FIG. 1A. Improvement in process performance of an EDCS may be obtained by improving (1) electrical conductivity within the electrochemical cell, (2) utilization of nickel hydroxide redox reaction, and/or (3) mass transport of gas into the electrode surface.

The electrochemical cell is connected to a power source which applies an electrical current/potential to the cell.

In accordance with a non-limiting embodiment of the present invention, this may be achieved by a one-sided (OS) coating on the electrode. One non-limiting way of coating only one side may be done by physical blocking of one geometrical face of the porous substrate before initiating electrodeposition of an electro-catalytic coating, such as but not limited to, nickel hydroxide coating. Physical blocking may be achieved by covering one face with an adhering sheet, which is peeled off after the electrodeposition step is over. The resulting electro-catalytic (e.g., nickel hydroxide) coating forms onto the porous substrate walls or wires and also fills its internal pores and coats externally one (out of two) geometrical faces. The other face in this electrode preparation approach is not coated.

The electro-catalytic coating includes a charge-storage compound that reacts to form hydroxide when acting as cathode and reacts to consume hydroxide or produce protons when acting as anode.

Such electrode morphology improves electrical conductivity within the electrochemical cell because the porous structure contacts the conductive layer with its uncoated side. Improved conductivity is then obtained since the porous substrate conducts electrons much better than nickel hydroxide, which in this case is only present on the electrode side that is near the separator. Improved electrical conductivity allows higher utilization of the nickel hydroxide active material at a lower overall potential, leading to improved energy consumption of the separation process.

Improved mass transport is obtained since the gas mixture can enter more easily the porous structure, in comparison to the prior art electrode structure (FIG. 1B) which includes nickel hydroxide layer on both sides. This is because in the prior art electrode, the nickel hydroxide layer coated on the substrate side that contacts the conductive layer physically blocks mass transport, making it more difficult for the gas mixture to reach the internal regions of the electrode, leading to lower electrode utilization and lower process performance (e.g., capture flux, normalized energy consumption).

Reference is now made to FIG. 2, which is a graphical illustration of CO₂ levels in the cathode outlet of the EDCS-based direct-air-capture (DAC) cell for the prior art double-sided (DS) coating on the electrode and the inventive one-sided (OS) coating on the electrode. Both tests included atmospheric air in the inlet gas, the same current density and the same (generic) cell hardware.

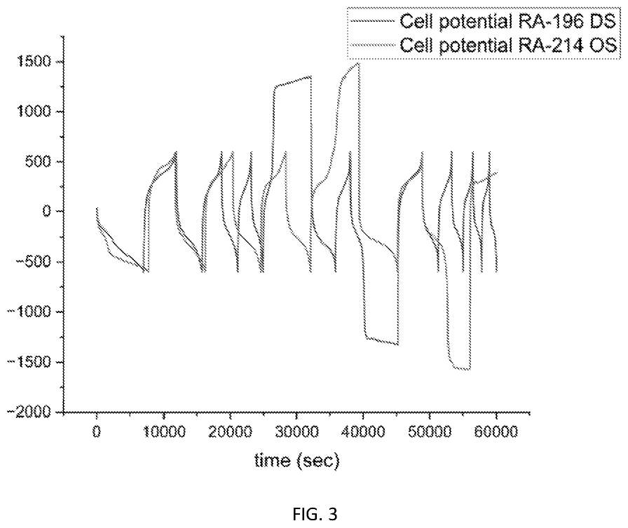

Reference is now made to FIG. 3, which is a graphical illustration of electrical potential of the EDCS-based DAC cell for the prior art double-sided (DS) coating on the electrode and the inventive one-sided (OS) coating on the electrode. Both tests included the same current density and the same (generic) cell hardware.

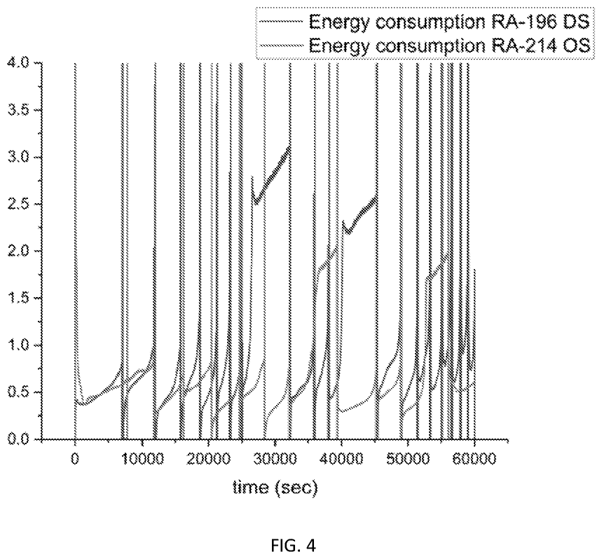

Reference is now made to FIG. 4, which is a graphical illustration of energy consumption of the EDCS-based DAC cell for the prior art double-sided (DS) coating on the electrode and the inventive one-sided (OS) coating on the electrode.

The graphs of FIGS. 2-4 clearly show the significant improvement of the invention over the prior art.

Other electro-catalytic coatings which may be used to carry out the invention, include without limitation, at least one of silver, a silver alloy, carbon-supported silver, a carbon-supported silver alloy, platinum, a platinum alloy, carbon-supported platinum, a carbon-supported platinum alloy, palladium, a palladium alloy, carbon-supported palladium, a carbon-supported palladium alloy, manganese oxide, a carbon-supported manganese oxide, cobalt oxide, a carbon-supported cobalt oxide, heteroatom-doped carbon (X—C, where X comprises one or more of N, C, B, P, S, Se, or O), metal-heteroatom-carbon (M-X—C, where X comprises one or more of N, C, B, P, S, Se, or O, and M comprises one or more of Fe, Ce, Cr, Cu, Co, Mo, Ni, Ru, Pd, Pt, Ir, Rb, Os, Ag, Au, Re, Ta, Ti, V, W, Mn, Zn, Sn, Sb, In, Ga, Bi, Pb, or Zr), a perovskite (ABX, where A comprises one or more of Ca, Sr, Ba, Sc, Y, La, Ce, Zr, Cu, Zn, Sb, Bi, B comprises one or more of Al, Ti, Mn, Fe, Co Ni, W, Pd, and X comprises one or more of O, Se, S), a carbon-supported perovskite (ABX₃ where A comprises one or more of Ca, Sr, Ba, Sc, Y, La, Ce, Zr, Cu, Zn, Sb, Bi, B comprises one or more of Al, Ti, Mn, Fe, Co Ni, W, Pd, and X comprises one or more of O, Se, S), or a combination thereof.

1. A device comprising:
an electrode for use in an electrochemically driven carbon dioxide separator (EDCS) comprising a porous and electrically conductive substrate having two opposing sides, wherein only one of said sides is coated with an electro-catalytic coating, the other side being an uncoated side, and wherein said electro-catalytic coating comprises a charge-storage compound that reacts to form hydroxide when acting as a cathode and reacts to consume hydroxide or produce protons when acting as an anode.

2. The device according to claim 1, wherein said electro-catalytic coating comprises a nickel hydroxide coating.

3. The device according to claim 1, comprising a first said porous and electrically conductive substrate and a second said porous and electrically conductive substrate separated from each other by an anion exchange separator to form an EDCS, said EDCS comprising an inlet and an outlet for gas flow through said first porous and electrically conductive substrate, said anion exchange separator and said second porous and electrically conductive substrate.

4. The device according to claim 3, wherein said uncoated sides of said first and second porous and electrically conductive substrates electrically contact said anion exchange separator.

5. The device according to claim 1, wherein said electro-catalytic coating comprises at least one of silver, a silver alloy, carbon-supported silver, a carbon-supported silver alloy, platinum, a platinum alloy, carbon-supported platinum, a carbon-supported platinum alloy, palladium, a palladium alloy, carbon-supported palladium, a carbon-supported palladium alloy, manganese oxide, a carbon-supported manganese oxide, cobalt oxide, a carbon-supported cobalt oxide, heteroatom-doped carbon (X—C, where X comprises one or more of N, C, B, P, S, Se, or O), metal-heteroatom-carbon (M-X—C, where X comprises one or more of N, C, B, P, S, Se, or O, and M comprises one or more of Fe, Ce, Cr, Cu, Co, Mo, Ni, Ru, Pd, Pt, Ir, Rh, Os, Ag, Au, Re, Ta, Ti, V, W, Mn, Zn, Sn, Sb, In, Ga, Bi, Pb, or Zr), a perovskite (ABX₃ where A comprises one or more of Ca, Sr, Ba, Sc, Y, La, Ce, Zr, Cu, Zn, Sb, Bi; B comprises one or more of Al, Ti, Mn, Fe, Co Ni, W, Pd, and X comprises one or more of O, Se, S), a carbon-supported perovskite (ABX₃ where A comprises one or more of Ca, Sr, Ba, Se, Y, La, Ce, Zr, Cu, Zn, Sb, Bi; B comprises one or more of Al, Ti, Mn, Fe, Co Ni, W, Pd, and X comprises one or more of O, Se, S), or a combination thereof.
